(19) United States
(12) Patent Application Publication
(10) Pub. No.: US 2002/0071456 A1
(43) Pub. Date: Jun. 13, 2002

(54) Miniature fabry-perot laser structure

(75) Inventors: Li Wu, Fuxing Investment District (CN); Baohua Li, Fuxing Investment District (CN); Feng Yu, Fuxing Investment District (CN); Tong Lin, Fuxing Investment District (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/012,944

(22) Filed: Dec. 10, 2001

(30) Foreign Application Priority Data
Dec. 12, 2000 (CN) 00261928.8

(51) Int. Cl. H01S 3/067; G02B 6/26

(52) U.S. Cl. 372/6; 385/39

(57) ABSTRACT

A laser structure, coupled to a LED pump, has an unguided uniform gain element having two mirrors forming a Fabry-Perot cavity. The gain element is coupled to an input waveguide and an output waveguide, wherein the output waveguide has a greater mode field diameter than the input waveguide. The output waveguide may be a TEC fiber. The structure is coupled to a LED pump.

### CROSS-REFERENCE TO RELATED APPLICATIONS

This application claims priority from Chinese Patent Application No. 00261928.8 filed Dec. 12, 2000.

### MICROFICHE APPENDIX

Not Applicable.

### TECHNICAL FIELD

The present application relates to fiber-coupled lasers, and specifically to miniature Fabry-Perot pumped lasers.

### BACKGROUND OF THE INVENTION

It is known that a fiber amplifier, having a length or a rare-earth doped fiber (typically erbium doped fiber) can be converted into a fiber laser if partly transparent mirrors are installed at two ends of the doped fiber section. The mirrors, typically integrated in the fiber, provide a resonant cavity (often called Fabry-Perot cavity) needed for the laser to generate its own light.

Unlike semiconductor lasers, often called diode lasers, fiber lasers rely on a uniform laser medium (doped glass) in the laser cavity. Fiber lasers require pump energy, the pump wavelength being typically converted into a specific output wavelength. The output wavelength can be tuned e.g. by the provision of a diffraction grating in the laser cavity.

Fiber lasers are related to solid-state lasers, where light from an external source excites a solid material between a pair of mirrors forming a resonant cavity. However, in a typical fiber laser, the cavity is usually of a substantial length and constitutes a light-guiding structure unlike a typical glass or crystal rod.

### SUMMARY OF THE INVENTION

The invention provides a laser structure forming a laser when coupled to a pump energy source, the structure comprising an unguided uniform (as opposed to a semiconductor structure) gain element having two mirrors forming a Fabry-Perot cavity therebetween, the gain element coupled to an input waveguide and an output waveguide, wherein the input waveguide and the output waveguide have dissimilar mode field diameters.

Typically, the mode field diameter of the output waveguide is greater than the modal diameter of the input waveguide. Preferably, the waveguides are lengths of optical fibers, the input waveguide being a single-mode fiber and the output waveguide being a multimode fiber or a single-mode fiber with a larger mode field diameter than the input waveguide.

The laser is coupled to a pump energy source through the input waveguide. The pump source may be a diode, e.g. a LED.

When coupled to the pump, the present invention provides a laser structure comprising: a pump, a first waveguide coupled to the pump and to a uniform unguided gain medium having a first and a second mirror forming a resonant cavity therebetween, the first waveguide coupled to the first mirror, and a second waveguide coupled to the second mirror, the modal diameters of the first and second waveguides being distinctly dissimilar so that the unguided emission generated within the cavity can be more efficiently coupled into the second (output) waveguide.

The invention eliminates the need for a lens to couple the laser emission into the output waveguide.

### BRIEF DESCRIPTION OF THE DRAWINGS

The invention will be described in greater detail by way of the following description in conjunction with the appended drawings, in which:

FIG. 1 is a prior art laser structure,

FIG. 2 is another prior art laser structure,

FIG. 3 is yet another prior art laser structure,

FIG. 4 is a schematic cross-sectional view of a laser structure of the invention,

FIG. 5 illustrates a resonant cavity of the laser structure of FIG. 4,

FIG. 6 is a schematic representation of another resonant cavity,

FIG. 7 is a representation of yet another resonant cavity, and

FIG. 8 illustrates an expanded mode field (TEC) fiber used in the structure of the invention.

It will be noted that throughout the appended drawings, like features are identified by like reference numerals.

### DETAILED DESCRIPTION OF THE PREFERRED EMBODIMENT

The present invention provides an inexpensive laser structure without the need to utilize a lens to couple light from the resonant cavity into an output waveguide or another receptacle.

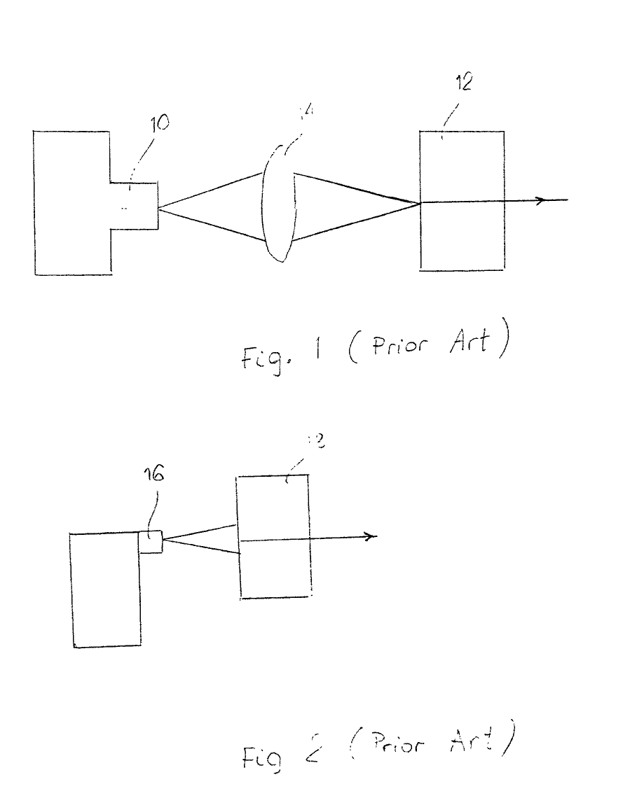

As shown in FIG. 1, a known laser structure has a pump 10 coupled to a gain medium (laser medium) 12 forming a resonant cavity through a lens 14. No output waveguide is provided.

FIG. 2 shows another prior art structure wherein a pump 16 is coupled to a laser medium 18 without a lens. This arrangement is likely to suffer a power loss.

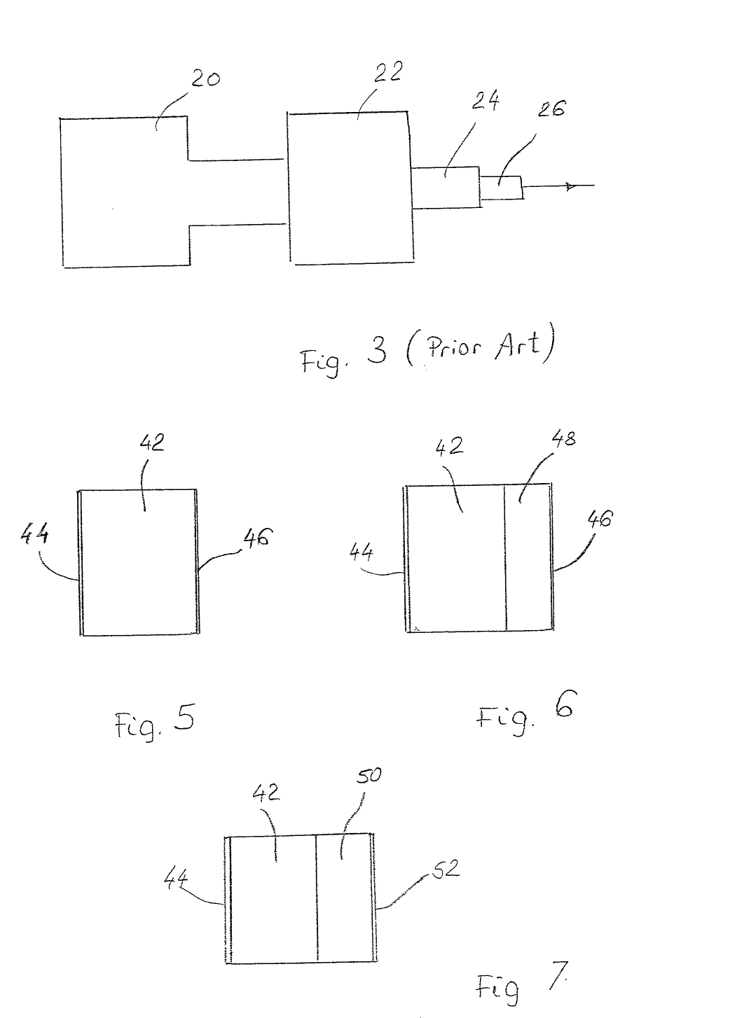

In the prior art arrangement illustrated in FIG. 3, the pump 20 is coupled directly to a laser cavity 22 and the output light from the cavity 22 is coupled through a lens 24 into a fiber 26.

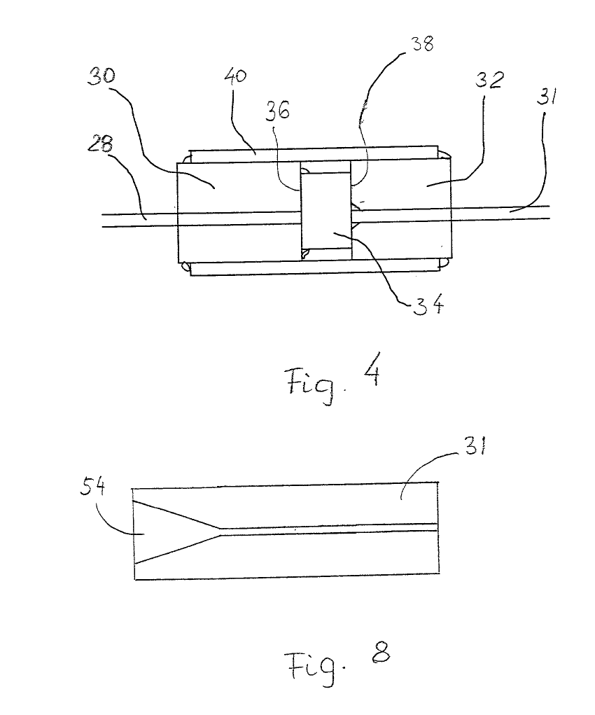

An exemplary structure of the invention is illustrated in FIG. 4. An input single-mode fiber 28 is mounted and glued inside a first ferrule 30 and an output TEC fiber 31 (100 μm mode-field diameter) is similarly mounted in a second ferrule 32. The enlarged core side of the TEC fiber 31 faces the cavity for efficient coupling of light from the cavity. Both ferrules are glued to a block of gain medium 34 having a partly reflective mirror 36 on one side and a partly reflective mirror 38 on the other side. The block and the mirrors 36, 38 define a Fabry-Perot cavity. The two ferrules with the block 34 are mounted in a metal sleeve 40. The fiber ends are also preferably glued to the block 34 with an optical epoxy resin, known in the art.

The laser structure as shown in FIG. 4 is about 3 mm in diameter and about 20 mm in length.

A diode pump, not shown in FIG. 4, is coupled to the input fiber 28.

Examples of the gain medium blocks are shown in FIGS. 5, 6 and 7. FIG. 5 illustrates a single cavity 42 formed of ND:YAG or Nd:YVO₄. The width of the cavity is in the order of 0.5-1 mm. An anti-reflective coating 44 is applied on the input side of the cavity and selected to pass pump wavelength (808 μm) and reflect the laser wavelength, 1064 nm. The coating 46 on the output side is selected for a reflectivity in the range 90-98% for the laser wavelength 1064 nm.

FIG. 6 illustrates a double-frequency laser cavity formed of a block 42 identical as in FIG. 5 and a of double-frequency non-linear crystal 48, the crystal selected from KTP, BBO and LiNO₃. The provision of the second crystal 48 results in the second mirror 46 passing a wavelength 532 nm, half of the initial wavelength.

The cavity of FIG. 7 is a Q-switched double cavity made of a Nd:YAG block 42 and a Q-switching Cr:YAG crystal 50. The width of the block 42 is approx. 1 mm and the width of the crystal 50 is approx. 0.25 mm. The cavity has a coating 44 on the block 42 and a mirror coating 52 of 85% at 1064 nm.

FIG. 8 illustrates in more detail the exemplary output waveguide, i.e. the expanded mode-field diameter (TEC) fiber 31 of FIG. 4. The expanded core section 54 is intended to broaden the acceptance angle for the output light from the laser cavity 34.

The embodiments of the invention described above are intended to be exemplary only. The scope of the invention is therefore intended to be limited solely by the scope of the appended claims.

We claim:

1. A laser structure comprising an input waveguide, an output waveguide and an unguided uniform gain element having two mirrors forming a Fabry-Perot cavity therebetween, the gain element coupled to the input waveguide and the output waveguide, wherein the input waveguide and the output waveguide have dissimilar mode field diameters.

2. The laser structure of claim 1 further comprising a pump energy source coupled to the cavity through the input waveguide.

3. The structure of claim 1 wherein the mode field diameter of the output waveguide is greater than the mode field diameter of the input waveguide.

4. The structure of claim 3 wherein the output waveguide is a multi-mode optical fiber.

5. The structure of claim 2 wherein the pump energy source is a light emitting diode.

6. The structure of claim 2 devoid of a focusing lens between the pump and the Fabry-Perot cavity.

7. The structure of claim 1 wherein the output waveguide is an expanded mode field fiber.

8. The structure of claim 1 wherein the Fabry-Perot cavity comprises a double-frequency block.

9. The structure of claim 1 devoid of a focusing lens between the Fabry-Perot cavity and the output waveguide.
